(19) United States
(12) Patent Application Publication
(10) Pub. No.: US 2026/0142071 A1
(43) Pub. Date: May 21, 2026

(54) COIL DEVICE

(71) Applicant: TDK CORPORATION, Tokyo (JP)

(72) Inventors: Toshiyuki HORIKAWA, Tokyo (JP); Shinji HIGA, Tokyo (JP)

(73) Assignee: TDK CORPORATION, Tokyo (JP)

(21) Appl. No.: 19/391,704

(22) Filed: Nov. 17, 2025

(30) Foreign Application Priority Data
Nov. 18, 2024 (JP) 2024-200914

(51) Int. Cl. H01F 27/29; H01F 27/02; H01F 27/28; H01F 27/32

(52) U.S. Cl. CPC H01F 27/29; H01F 27/02; H01F 27/2823; H01F 27/325

(57) ABSTRACT

A coil device including a bobbin 3, a coil 1 including wound wire parts 10 and 20 wound around the bobbin, a terminal 71 connecting to the coil 1, and a cover 5 protecting the wound wire part 10. The cover 5 includes a cover main body 50 covering an outside in a height direction perpendicular to a winding axis of the of the wound wire part 10. The terminal 71 is mounted on the cover main body. The terminal 71 includes a wire connection part 71a connecting with a lead part 11 pulled out from the wound wire part 10, and an external connection part 71c connected to the wire connection part 71a.

### TECHNICAL FIELD

The present disclosure relates to a coil device suitable used as a transformer and so on.

### BACKGROUND

As disclosed in Patent Document 1, there are transformers in which a coil is arranged so that a winding axis of the coil is parallel to a circuit board. In such transformers, terminal bocks are provided on both ends of the bobbin, and the terminal blocks are placed on the circuit board; and thereby, a transformer is mounted on the circuit board.

However, in such transformers, in order to ensure the insulation between the wound wire part of the coil and the terminal, the terminal and the wound wire part have a distance between each other. Thus, the device as a whole is large.

### PRIOR ART DOCUMENT

### Patent Document

### Patent Document 1 JP Patent Application Laid Open No.2008-171880

### SUMMARY

The present disclosure is achieved in view of such circumstances, and the object is to provide a coil device with improved insulation property and capable of saving spaces.

A coil device according to one embodiment of the present disclosure includes: a bobbin, a coil including a wound wire part wound around the bobbin, a terminal connecting to the coil, and a cover protecting the wound wire part; wherein the cover includes a cover main body covering an outside in a height direction perpendicular to a winding axis of the of the wound wire part, the terminal is mounted on the cover main body, and the terminal includes a wire connection part connecting with a lead part pulled out from the wound wire part and an external connection part connected to the wire connection part.

By configuring as such, the cover enables the coil device to protect the wound wire part without using too much space, and sufficient space for insulation can be secured between the terminal and the wound wire part. The position where the terminal is pulled out can be designed freely on the cover main body. Hence, according to such configuration, the position where the terminal is pulled out can be determined even more freely. Therefore, according to this coil device, even when the winding axis of the coil and the mounting surface is arranged parallel to each other, insulation property between the wound wire part of the coil and the terminal is enhanced and also it is possible to save space.

Preferably, the external connection part may be arranged closer to the winding axis than to the wire connection part viewing in the height direction. By configuring as such, a mounting area of the coil device can be decreased.

Preferably, the cover main body may bridge one flange and the other flange of the bobbin. By configuring as such, the wound wire part of the coil wound around the bobbin can be securely protected by the cover; thus, the insulation property can be enhanced.

Preferably, the cover main body may bridge one outer leg part and the other outer leg part of a core installed to the bobbin. By configuring as such, the wound wire part of the coil can be securely protected by the cover; thus, the insulation property can be enhanced.

Preferably, the external connection part may be arranged between the one flange and the other flange of the bobbin. By configuring as such, the mounting area of the coil device when mounted on the circuit board or so can be decreased.

Preferably, the wire connection part may be arranged at an inside than an outer surface in a width direction of a core installed to the bobbin. By configuring as such, the wire connection part does not project out of the core during the manufacturing of the coil device or when mounting the coil device, or after mounting the coil device. Thus, the wire connection part can be protected effectively which improves the reliability of the wire connection part. Also, this contributes to saving spaces.

Preferably, the wire connection part may be arranged at an outside of the bobbin and the cover main body viewing in the height direction. Prior to installing the core, there are rooms above and below the wire connection part, thus the lead part of the coil and the wire connection part can be easily connected using a bonding means (or any other means) such as heat-compress bonding. Therefore, the coil device can be manufactured easily.

Preferably, the external connection part may project out from a surface of the cover main body. By configuring as such, the external connection part projecting out from the cover main body can be inserted in the hole formed on the circuit board, hence the coil device can be easily mounted on the circuit board and the mounting strength can be improved.

The terminal may be press-fit or insert molded to the cover main body.

### BRIEF DESCRIPTION DRAWINGS

FIG. 1 is an overall perspective view of a coil device according to one embodiment of the present disclosure.

FIG. 2 is an exploded perspective view of the coil device shown in FIG. 1 .

FIG. 3 is a partial perspective view showing configurations of coil and bobbin of the coil device shown in FIG. 1 .

FIG. 4 is a partial perspective view showing a configuration of a core of the coil device shown in FIG. 1 .

FIG. 5 is a partial perspective view showing a configuration of a cover of the coil device shown in FIG. 1 .

FIG. 6 shows a state before mounting the cover on the coil device shown in FIG. 1 .

FIG. 7 is a plan view of the coil device shown in FIG. 1.

FIG. 8 is a cross-sectional view along a VIII-VIII line of the coil device shown in FIG. 1.

FIG. 9 is a cross-sectional view of the coil device according to another embodiment of the present disclosure.

### DETAILED DESCRIPTION

Embodiments of the present disclosure are explained below using the figures. Note that, the figures are shown schematically as examples for better understanding of the present disclosure, and the appearances and dimensional proportion may not be the exact same of the actual device. Also, the present disclosure is not limited to the below embodiments.

### First Embodiment

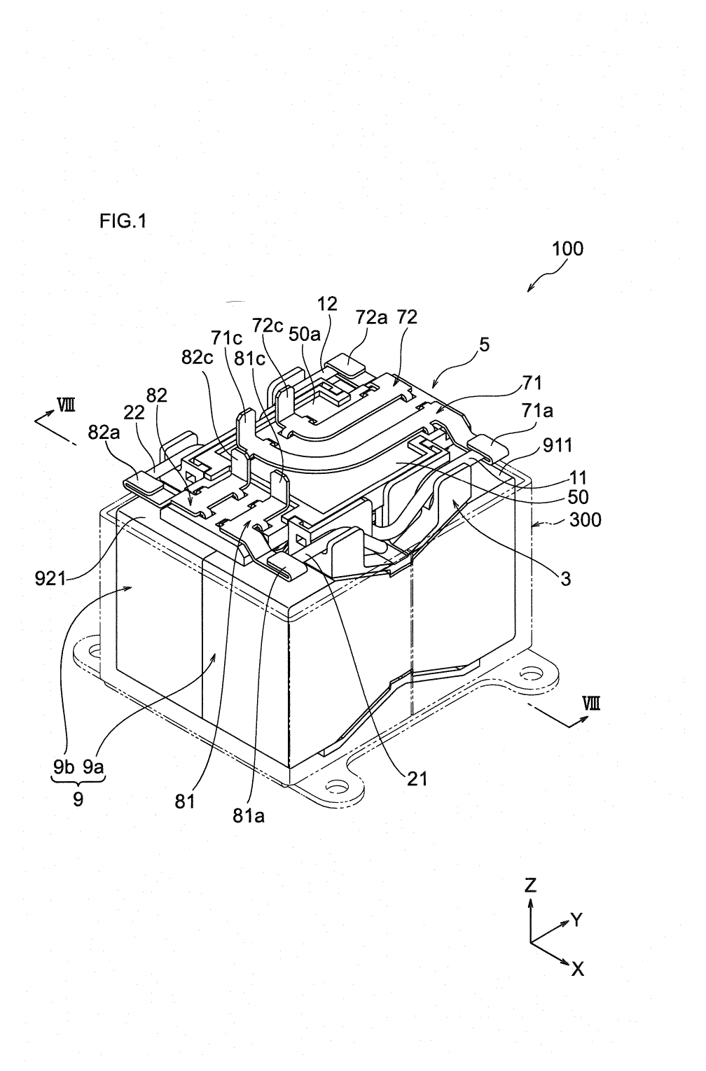

A coil device 100 according to the present embodiment shown in FIG. 1 has a function as a transformer as one example, and it can be used as a power circuit of an onboard charger for EV (Electric Vehicle), PHV (Plug-in Hybrid Vehicle), or commuter vehicle; as a power circuit of domestic or industrial electronic device; or as a power circuit of a computer device.

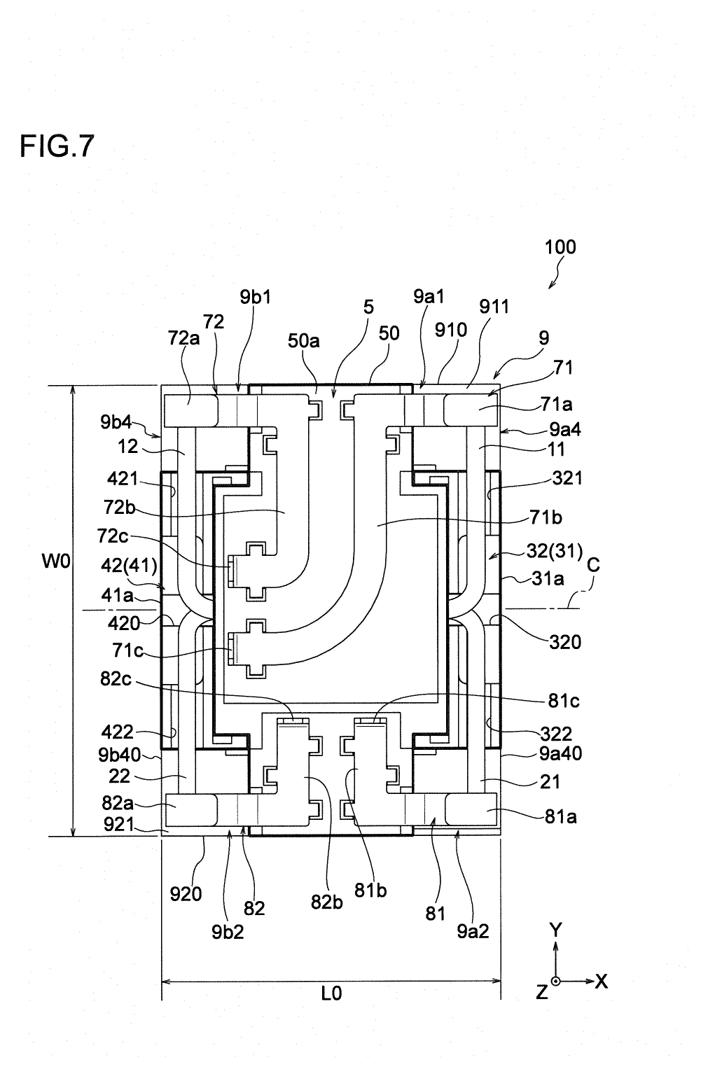

A size of the coil device 100 is not particularly limited, and for example, a length L0 in the X-axis direction (see FIG. 7) may be 1 cm to 20 cm, a width W0 in the Y-axis direction (see FIG. 7 ) may be 1 cm to 20 cm, and a height in the Z-axis direction may be 1 cm to 20 cm.

Note that, in the figure, the X-axis is along a winding axis C of the coil, and the X-axis, Y-axis, and Z-axis are perpendicular to each other. Also, in below description, the Y-axis direction may be referred to as a width direction and the Z-axis direction may be referred to as a height direction. The direction toward the center of the coil device 100 may be referred to as “inside” or “inner side”, and the direction away from the center of the coil device 100 may be referred to as “outside” or “outer side”. Also, according to the direction in the figure, the direction of the tip of the arrow of the Z-axis may be referred to as “upper side”.

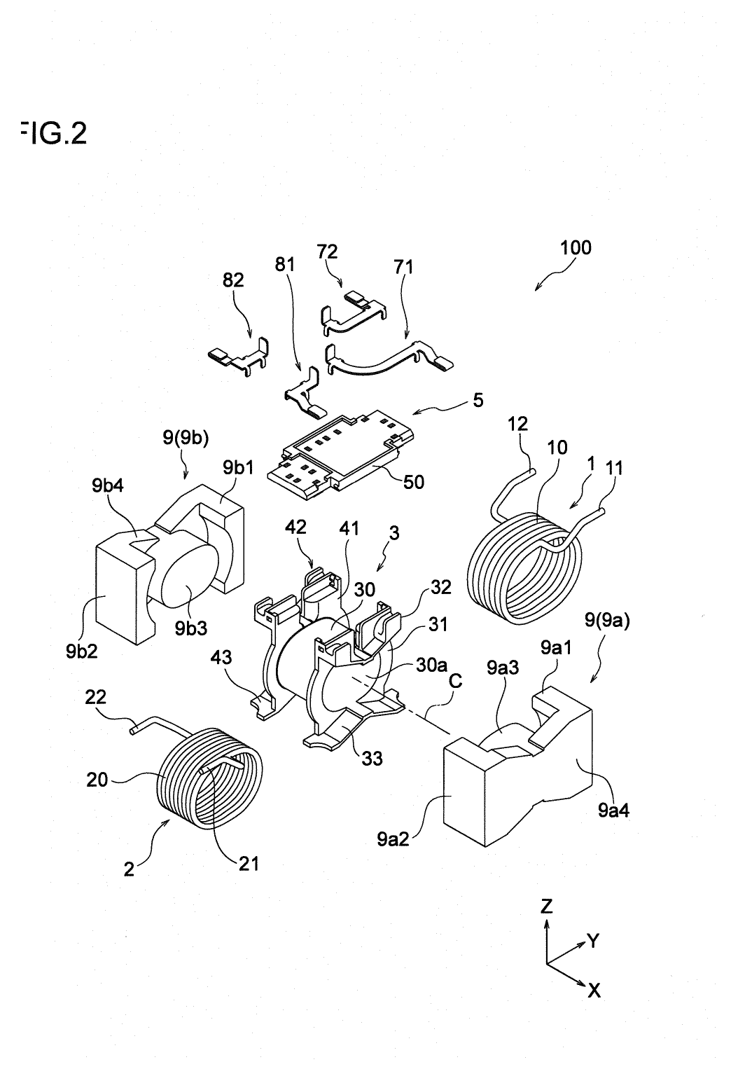

As shown in FIG. 2, the coil device 100 schematically includes coils 1 and 2, a bobbin 3 where the coils 1 and 2 are wound around, a core 9 which is installed to the bobbin 3, and a cover 5 for protecting wound wire parts 10 and 20 of the coil. Terminals 71, 72, 81, and 82 are mounted on the cover 5. As shown in FIG. 1, the coil device 100 is accommodated in a case 300, and the coil device 100 may be mounted on a circuit board or so for use.

As shown in FIG. 2, the bobbin 3 schematically includes a winding axis part 30 extending along the X-axis, and flanges 31 and 41 at both ends in the X-axis direction of the wound wire part 30. The winding axis part 30 has a through hole 30a penetrating through in the X-axis direction. Middle leg parts 9a3 and 9b3 of the core 9 are inserted in the through hole 30a.

The bobbin 3 is made of an insulation member which insulates between the coils 1 and 2 and the middle leg parts 9a3 and 9b3 of the core 9. Examples of such insulation member include plastics such as PPS, PET, PBT, and LCP.

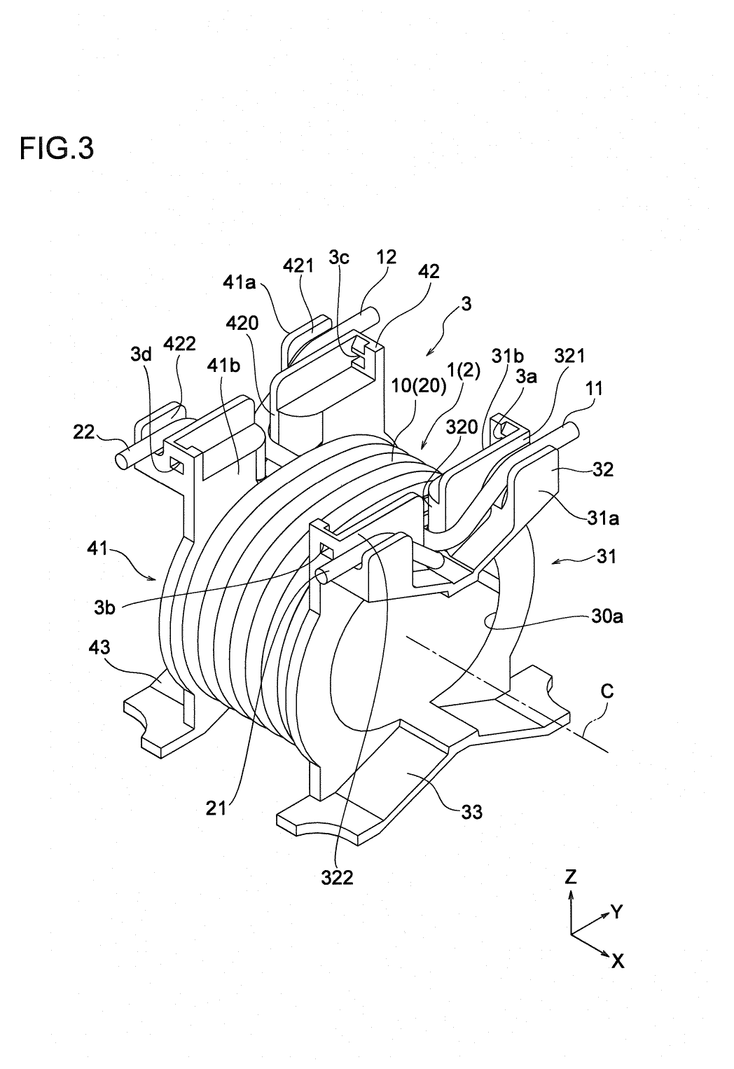

As shown in FIG. 3, at the winding axis part 30, the wound wire part 10(20) is formed by winding the coil 1(2) around the winding axis C. In the present embodiment, the wound wire part 10 is wound around the wound wire part 20 of the coil 2 wound around the winding axis part 30 (see ). Lead parts 11 and 12 are pulled out from the wound wire part 10. Similarly, lead parts 21 and 22 are pulled out from the wound wire part 20.

As the coils 1 and 2, any known conductive wires can be used. Examples of such wires include a known insulation coated wire which the surface of a conductive wire such as copper is insulation coated with polyimide film and the like. The coils 1 and 2 may be each configured of a single wire, or stranded wires. A wire size (diameter) of the coils 1 and 2 may be 1.0 to 3.0 mm. The wire sizes of the coils 1 and 2 may be the same or different.

The coil 2 can be wound around the outer circumference of the winding axis part 30 using for example an automatic coil winding machine. Similarly, the coil 1 can be wound around the outer circumference of the wound wire part 20 using an automatic coil winding machine.

As shown in FIG. 3, at the upper side in the Z-axis direction of the flange 31, a lead holder 32 is formed where the lead part of the coil is pulled out. The lead holder 32 has a notch 320 which is formed by cutting out from the outer surface 31a located at the outside in the X-axis direction to the inner surface 31b located at the inside in the X-axis direction. The lead parts 11 and 21 are pulled out from the wound wire parts 10 and 20 and are passed through the notch 320, then pulled toward the outside in the X-axis direction.

As shown in FIG. 3, the lead holder 32 has a lead guiding passage 321 to pull out the lead part 11 to one side in the Y-axis direction. The lead holder 32 has a lead guiding passage 322 to pull out the lead part 21 to the other side in the Y-axis direction. The lead holder 32 has engagement holes 3a and 3b for installing the cover.

As shown in FIG. 3, at the upper side in the Z-axis direction of the flange 41, a lead holder 42 is formed where the lead part of the coil is pulled out. The lead holder 42 has a notch 420 which is formed by cutting out from the outer surface 41a located at the outside in the X-axis direction to the inner surface 41b located at the inside in the X-axis direction. The lead parts 12 and 22 are pulled out from the wound wire parts 10 and 20, and are passed through the notch 420, then pulled toward the outside in the X-axis direction.

As shown in FIG. 3, the lead holder 42 has a lead guiding passage 421 to pull out the lead part 12 to one side in the Y-axis direction. The lead holder 42 has a lead guiding passage 422 to pull out the lead part 22 to the other side in the Y-axis direction. The lead holder 42 has engagement holes 3c and 3d for installing the cover.

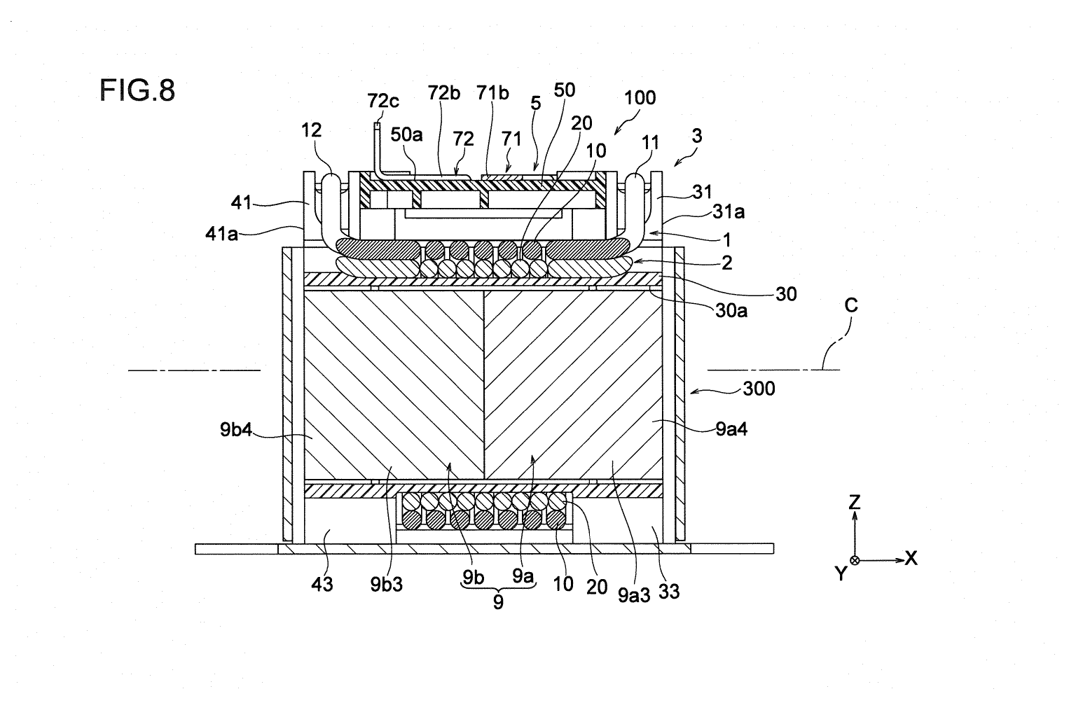

As shown in FIG. 3, mounting parts 33 and 43 are respectively formed at the lower side in the Z-axis direction of the flanges 31 and 41. As shown in FIG. 8, the mounting parts 33 and 43 are mounted on the bottom of a case 300.

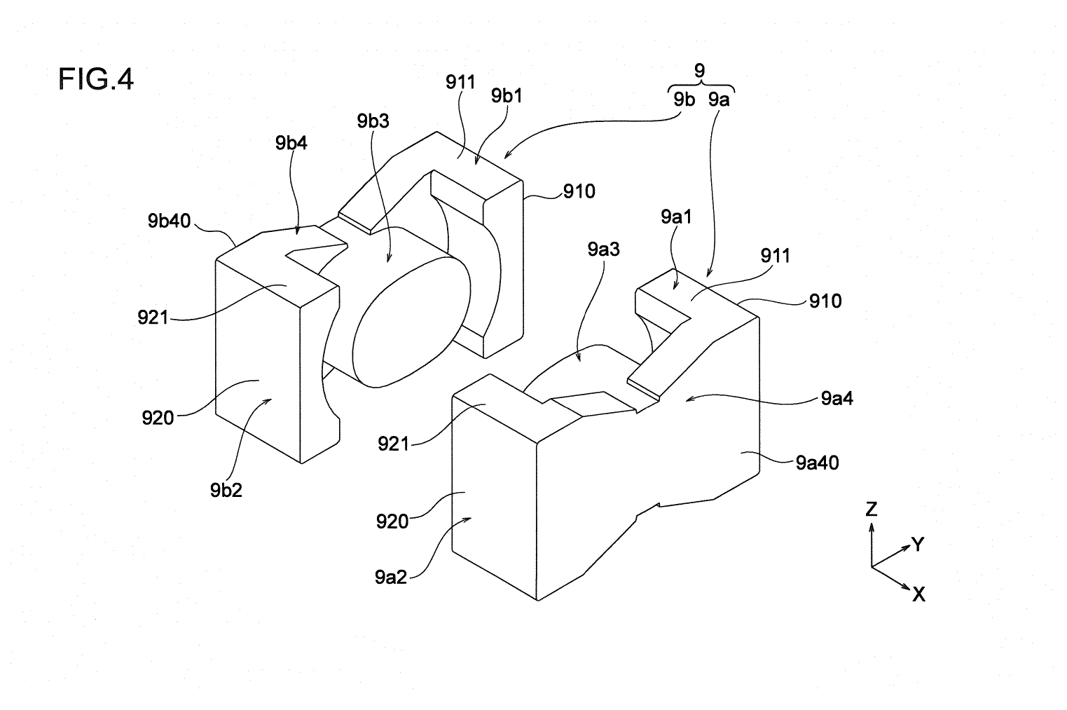

As shown in FIGS. 2 and 4 , the core 9 can be separated into a core 9a and a core 9b. The core 9a and the core 9b are both so-called E-shape cores, but these are not limited to the E-shaped cores; and for example, the cores 9a and 9b may be formed by combining a U-shaped core and a plate core. A material of the core 9 may be a magnetic material such as ferrite, but it is not limited to this. Note that, the core 9a and the core 9b may be configured of the same material. However, the material does not necessarily have to be the same.

As shown in FIG. 4, the core 9a has outer leg parts 9a1 and 9a2, a middle leg part 9a3, and a base part 9a4. The outer leg part 9a1 extends from one end in the Y-axis direction of the base part 9a4 toward the inside along the X-axis direction. The outer leg part 9a2 extends from the other end in the Y-axis direction of the base part 9a4 toward the inside along the X-axis direction.

As shown in FIG. 4, the middle leg part 9a3 is positioned between the outer leg part 9a1 and the outer leg part 9a2; and the middle leg part 9a3 extends from approximately center in the Y-axis direction of the base part 9a4 towards inside along the X-axis. The middle leg part 9a3 is inserted in the through hole 30a of the winding axis part 30 of the bobbin 3 (see FIG. 3), and the outer leg parts 9a1 and 9a2 are arranged at the outside of the through hole 30a.

As shown in FIG. 4, the core 9b has outer leg parts 9b1 and 9b2, a middle leg part 9b3, and a base part 9b4; and the core 9b has approximately symmetrical shape as the core 9a along the X-axis. The middle leg part 9b3 contacts the middle leg part 9a3 in the through hole 30a of the bobbin 3 (see FIG. 8). The outer leg part 9b1 contacts the outer leg part 9a1 at the outside of one side in the Y-axis direction of the through hole 30a. The outer leg part 9b2 contacts the outer leg part 9a2 at the outside of the other side in the Y-axis direction of the through hole 30a. Note that, the core 9a and the core 9b may not contact each other, and some gap may be formed between the two.

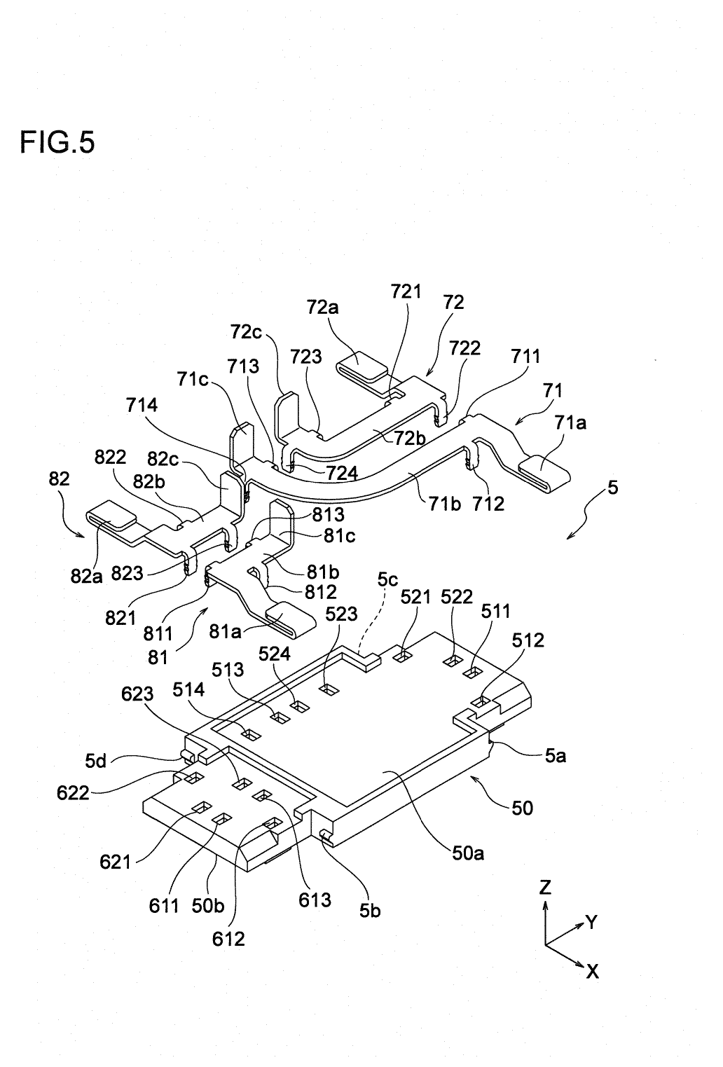

As shown in FIG. 5, the cover 5 has a cover main body 50 of a plate shape. Also, the cover 5 includes terminals 71, 72, 81, and 82 which are mounted on the cover main body 50. The cover main body 50 is configured of an insulation member.

Examples of such insulation member includes plastics such as PPS, PET, PBT, and LCP. The cover 50 may be configured of the same material as the bobbin 3, but these do not necessarily have to be made of the same material. The terminals 71, 72, 81, and 82 can be easily formed from a conductive plate material such as a metal plate made of copper using press processing. Also, plating using tin and the like may be formed on the surface of the terminals 71, 72, 81, and 82.

As shown in FIG. 5, the terminal 71 has a wire connection part 71a where the lead part of the coil is connected, the external connection part 71c, and an intermediate part 71b which connects the external connection part 71c and the wire connection part 71a. The terminal 71 may be mounted on the cover main body 50 using an appropriate method. Specifically, the cover main body 50 has press-fit holes 511 to 514 which are at positions corresponding to fitting claws 711 to 714 of the terminal 71. By pressing the fitting claws 711 to 714 in these press-fit holes 511 to 514, the terminal 71 can be mounted on at the predetermined position of the cover main body 50.

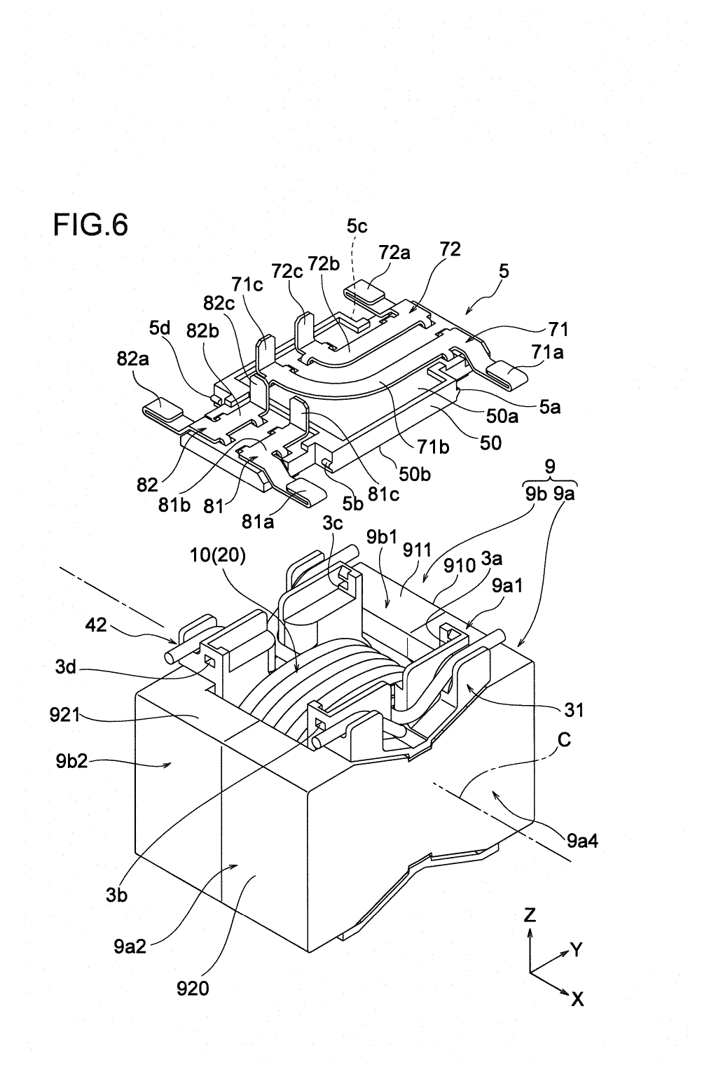

As shown in FIG. 6, the intermediate part 71b is arranged along the upper face (surface) 50a of the cover main body 50. The wire connection part 71a is molded at the inside in the Z-axis direction than the upper face 50a of the cover main body 50. Also, the external connection part 71c projects outward in the Z-axis direction from the upper face (surface) 50a of the cover main body 50.

As shown in FIG. 5, similar to the terminal 71, the terminal 72 also has an external connection part 72c, a wire connection part 72a, and an intermediate part 72b. Similar to the terminal 71, also in the case of the terminal 72, fitting claws 721 to 724 are pressed into press- fit holes 521 to 524; thereby, the terminal 72 can be mounted on at the predetermined position of the cover main body 50.

As shown in FIG. 6, the intermediate part 72b is arranged along the upper face (surface) 50a of the cover main body 50. The wire connection part 72a is molded at the inside in the Z-axis direction than the upper face 50a of the cover main body 50. Also, the external connection part 72c projects outward in the Z-axis direction from the upper face (surface) 50a of the cover main body 50.

As shown in FIG. 5, similar to the terminal 71, the terminal 81 also has an external connection part 81c, a wire connection part 81a, and an intermediate part 81b. Similar to the terminal 71, also in the case of the terminal 81, fitting claws 811 to 813 are pressed into press-fit holes 611 to 613; thereby, the terminal 81 can be mounted on at the predetermined position of the cover main body 50.

As shown in FIG. 6, the intermediate part 81b is arranged along the upper face (surface) 50a of the cover main body 50. The wire connection part 81a is molded at the inside in the Z-axis direction than the upper face 50a of the cover main body 50. Also, the external connection part 81c projects outward in the Z-axis direction from the upper face (surface) 50a of the cover main body 50.

As shown in FIG. 5, similar to the terminal 72, the terminal 82 also has an external connection part 82c, a wire connection part 82a, and an intermediate part 82b. Similar to the terminal 72, also in the case of the terminal 82, fitting claws 821 to 823 are pressed into press-fit holes 621 to 623; thereby, the terminal 82 can be mounted on at the predetermined position of the cover main body 50.

As shown in FIG. 6, the intermediate part 82b is arranged along the upper face (surface) 50a of the cover main body 50. The wire connection part 82a is molded at the inside in the Z-axis direction than the upper face 50a of the cover main body 50. Also, the external connection part 82c projects outward in the Z-axis direction from the upper face (surface) 50a of the cover main body 50.

As such, in the present embodiment, the terminals 71, 72, 81, and 82 are press fit to the cover main body 50. Note that, a method of fitting the terminals to the cover main body 50 is not limited to press-fitting. For example, a terminal may be mounted on the cover main body 50 by insert molding the terminal which molds the cover main body 50 by surrounding the terminal with the insulation member, or the terminal may be mounted on using an adhesive to the surface of the cover main body.

As shown in ,FIG. 6 the cover main body 50 has engaging claws 5a to 5d. The engaging claw 5a engages with an engaging hole 3a of the bobbin. The engaging claw 5b engages with an engaging hole 3b of the bobbin. The engaging claw 5c engages with an engaging hole 3c of the bobbin. The engaging claw 5d engages with an engaging hole 3d of the bobbin. As such, by engaging the engaging claw and the engaging hole, the bobbin 3 can be easily installed. The cover 5 is arranged so that the cover main body 50 bridges one flange 31 and the other flange 41 of the bobbin 3 along the X-axis direction (see FIG. 7). Therefore, foreign objects hardly enter in the wound wire part while assembling.

The cover main body 50 bridges the outer leg parts 9a1 and 9b1 of one side of the core 9 and the outer leg parts 9a2 and 9b2 of the other side of the core 9 (see FIG. 7). As such, by installing the cover 5 to the bobbin 3, in the present embodiment, the cover 5 completely covers the upper side in the Z-axis direction of the wound wire part of the coil; however, the wound wire part of the coil may be partially exposed.

Note that, in FIG. 6, before the cover 5 is mounted on the bobbin, the core 9 is installed to the bobbin 3; however, the steps of assembling process are not limited to this order. The cover 5 may be mounted on the bobbin 3 and terminals and the lead parts are connected, then the core 9 may be installed to the bobbin 3.

In the present embodiment, a lower face 50b of the cover main body 50 may be in contact with the upper face 911 located at the side of the outer leg parts 9a1 and 9b1 and the upper face 921 located at the side of the outer leg parts 9a2 and 9b2, or the lower face 50b may not be in contact with these. When the lower face 50b of the cover main body 50 contacts the upper face 911 located at the side of the outer leg parts 9a1 and 9b1 and the upper face 921 located at the side of the outer leg parts 9a2 and 9b2, the wound wire parts 10 and 20 can be protected even more effectively.

FIG. 7 is a plan view of the coil device 100 when it is viewed from above in the Z-axis direction. As shown in FIG. 7, the wire connection part 71a of the terminal 71 extends along the X-axis direction, and it is arranged at the upper side in the Z-axis direction of the upper face 911 located at the outer leg part 9a1 side of the core 9 (see FIG. 1). The wire connection part 71a holds the lead part 11 pulled out along the Y-axis direction at outside of the cover main body 50 and the lead holder 32. Also, the wire connection part 71a is arranged at the inside than the outer face 910 in the width direction (Y-axis direction) of the core 9. Also, the wire connection part 71a is arranged at the inside than the outer face 31a of the flange 31 in the X-axis direction. The intermediate part 71b configures a wiring path between the end of wire connection part 71a located at the inside along the X-axis direction and the external connection part 71c.

As shown in FIG. 7, the wire connection part 72a of the terminal 72 extends along the X-axis direction, and it is arranged at the upper side in the Z-axis direction of the upper face 911 located at the outer leg part 9b1 side of the core 9 (see FIG. 1). The wire connection part 72c holds the lead part 12 pulled out along the Y-axis direction at outside of the cover main body 50 and the lead holder 42. Also, the wire connection part 72a is arranged at the inside than the outer face 910 in the width direction (Y-axis direction)of the core 9. Also, the wire connection part 72a is arranged at the inside than the outer face 41a of the flange 41 in the X- axis direction. The intermediate part 72b configures a wiring path between the end of wire connection part 72a located at the inside along the X-axis direction and the external connection part 72c.

As shown in FIG. 7, the wire connection part 81a of the terminal 81 extends in the X-axis direction, and it is arranged at the upper side in the Z-axis direction of the upper face 921 located at the outer leg part 9a2 side of the core 9 (see FIG. 1). The wire connection part 81a holds the lead part 21 pulled out along the Y-axis direction at outside of the cover main body 50 and the lead holder 32. Also, the wire connection part 81a is arranged at the inside than the outer face 920 in the width direction (Y-axis direction) of the core 9. Also, the wire connection part 81a is arranged at the inside than the outer face 31a of the flange 31 in the X-axis direction. The intermediate part 81b configures a wiring path between the end of wire connection part 81a located at the inside along the X-axis direction and the external connection part 81c.

As shown in FIG. 7, the wire connection part 82a of the terminal 82 extends along the X-axis direction, and it is arranged at the upper side in the Z-axis direction of the upper face 921 located at the outer leg part 9b2 side of the core 9 (see FIG. 1). The wire connection part 82a holds the lead part 22 pulled out along the Y-axis direction at outside of the cover main body 50 and the lead holder 42. Also, the wire connection part 82a is arranged at the inside than the outer face 920 in the width direction (Y-axis direction) of the core 9. Also, the wire connection part 82a is arranged at the inside than the outer face 41a of the flange 41 in the X- axis direction. The intermediate part 82b configures a wiring path between the end of wire connection part 82a located at the inside along the X-axis direction and the external connection part 82c.

As shown in FIG. 7, the external connection part 71c is arranged closer to the winding axis C (closer to the center) than to the wire connection part 71a. Similarly, the external connection part 72c is arranged closer to the winding axis C than the wire connection part 72a. Similarly, the external connection part 81c is arranged closer to the winding axis C than to the wire connection part 81a. The external connection part 82c is also arranged closer to the winding axis C than to the wire connection part 82a.

As shown in FIG. 7, when viewing along the Z-axis direction, the wire connection parts 71a, 72a, 81a, and 82a of the terminals are arranged towards the center side than the outer faces 910, 920, 9a40, and 9b40 of the core 9. Also, the wire connection parts 71c, 72c, 81c, and 82c of the terminals are arranged towards the center side than the outer faces 910, 920, 9a40, and 9b40 of the core 9.

As shown in FIG. 1, in the coil device 100, the cover 5 functions as the terminal block. A method for mounting the coil 100 is not particularly limited, and examples include of mounting the coil device 100 by contacting the upper face 50a (surface) of the cover 5 to the circuit board (not shown in the figure). In the case of mounting the coil device 100 in such manner, at the outside of the outer face 910, 920, 9a40, and 9b40 of the core, terminals are not provided, as it is shown in FIG. 7. Thus, a mounting area of the coil device 100 can be reduced.

As shown in FIG. 1, the external connection parts 71c, 72c, 81c, and 82c project upward in the Z-axis direction from the upper face 50a (surface) of the cover main body 50. By configuring as such, the external connection parts 71c, 72c, 81c, and 82c can be inserted in the holes formed on the circuit board; hence, the mounting can be done easily and the mounting strength can be improved.

As shown in FIG. 8, the cover 5 covers the upper side in the Z-axis direction of the wound wire parts 10 and 20 of the coil. Thus, when the coil device 100 is mounted, it is possible to prevent foreign objects from entering into the wound wire parts 10 and 20. Also, the cover main body 50 insulates the terminals 71, 72, 81, and 82 arranged on the upper face 50a and the wound wire parts 10 and 20; hence, the external connection parts 71c, 71c, 72c, 81c, and 82c can be provided to the center side of the cover main body 50 (see FIG. 1). Hence, it is possible to reduce the mounting area of the coil device 100 when it is mounted on the circuit board or so.

As shown in FIG. 7, in such coil device 100, it is possible to freely design the position of the lead out on the cover 5; hence, the positions where the terminals 71, 72, 81, and 82 are pulled out can be determined even more freely. In the present embodiment, the external connection parts 72c, 81c, and 82c are arranged between the outer faces 31a and 41a of the both flanges of the bobbin. Therefore, the coil device 100 enables to improve the insulation property and to reduce the mounting area.

As shown in FIG. 7, the cover main body 50 bridges one flange 31 and the other flange 41 of the bobbin 3 along the X-axis direction. The cover main body 50 bridges the outer leg parts 9a1 and 9b1 and the outer leg parts 9a2 and 9b2 of the core 9. Therefore, the wound wire parts 10 and 20 of the coil can be securely protected by the cover 5, and the insulation property can be enhanced. Also, in the coil device 100, the cover 5 including the terminals 71, 72, 81, and 82 are arranged to the inside in the X-axis direction and the Y-axis direction of the bobbin and the core; thus, it is possible to achieve compact product.

As shown in FIG. 7, the wire connection parts 71a, 72a, 81a, and 82a are arranged at the inside than the outer faces 910 and 920 in the Y-axis direction of the core 9. By configuring as such, the wire connection parts 71a, 72a, 81a, and 82a do not project out of the core 9 during the manufacturing of the coil device 100 or when mounting it, or after mounting the coil device. Thus, the wire connection parts 71a, 72a, 81a, and 82a can be protected effectively which improves reliability of the wire connection part. Also, this contributes for saving spaces.

As shown in FIG. 7, the lead parts 11 and 12 are pulled out towards the outer face 910 of the core 9 along the Y-axis direction. The lead parts 21 and 22 are pulled out towards the outer face 920 of the core 9 along the Y-axis direction. The wire connection parts 71a, 72a, 81a, and 82a are arranged outside of the bobbin and the cover main body. In the case of installing the core 9 to the bobbin 3 after mounting the cover 5 on the bobbin 3 and connecting the terminal and the lead part, there are spaces below and above the wire connection parts 71a, 72a, 81a, and 82a before the core 9 is installed to the bobbin 3. In this case, the lead parts 11, 12, 21, and 22 of the coil and the wire connection parts 71a, 72a, 81a, and 82a can be easily connected using a bonding means such as heat-compress bonding. Thus, the coil device can be manufactured easily. Further, as shown in FIG. 7, the wire connection parts 71a, 72a, 81a, and 82a are arranged to the inside of the outline of the coil device 100; thus, a connection malfunction caused by contacting other devices is unlikely to occur while manufacturing the coil device. Also, it is possible to reduce the mounting area of the coil device.

The wire connection part of the terminal can be connected with the lead part of the coil, for example, by removing the insulation layer of the lead part and carrying out heat compression bonding such as fusing. Other than this, examples of the method for bonding the wire connection part and the lead part include solder welding and laser welding, and any other appropriate method.

Although it is not shown in the figure, a potting resin may be placed inside the case 300 so that the resin contacts the coil device 100. The potting resin may be placed in the case 300 after the coil device 100 is placed in the case 300, or the resin may be placed in the case 300 in advance. Note that, the potting resin does not necessarily have to cover the entire coil device 100, and the resin may be placed in the case 300 such that the coil device 100 is partially covered with resin.

The coil device 100 can improve the insulation property, and also space-saving can be achieved. Further, the coil device 100 has a simple configuration, thus it can be assembled easily.

### Second Embodiment

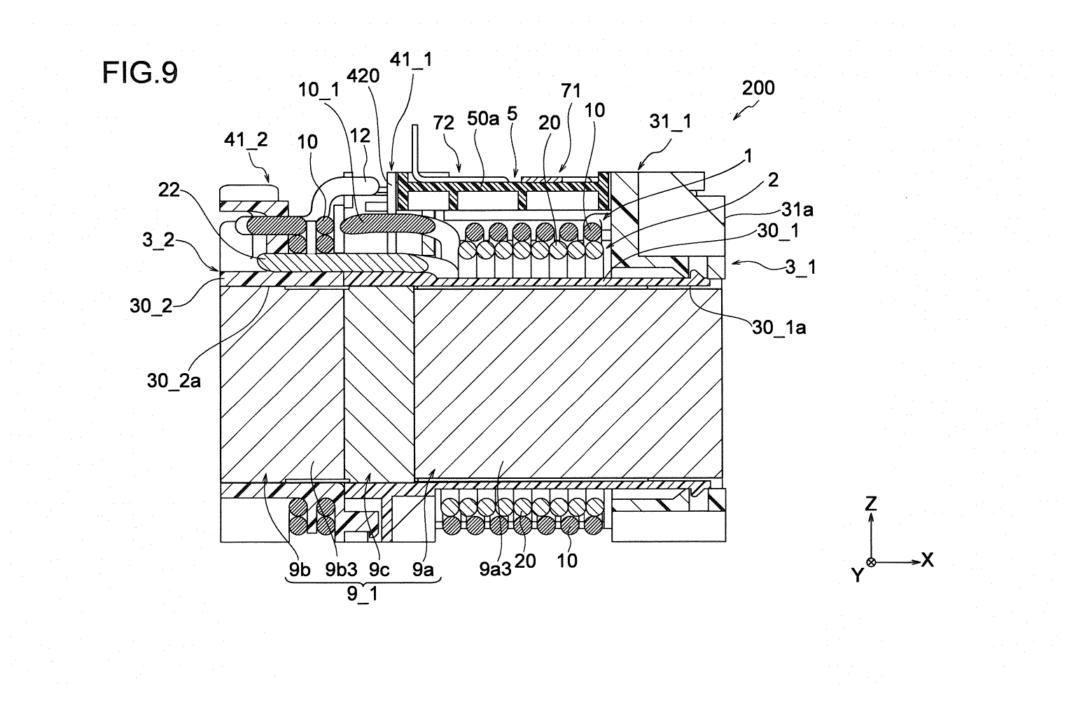

As shown in FIG. 9, a coil device 200 according to the present embodiment is basically configured similar to the coil device 100 of the first embodiment, except that a bobbin and a core of the second embodiment are configured differently. The coil device 200 of the second embodiment and the coil device 100 of the first embodiment exhibits the similar effects. In below description, the configurations common with the first embodiment are omitted as much as possible from explaining, and the same reference numbers as the first embodiment are given to the similar configurations as necessary.

As shown in FIG. 9, the coil device 200 of the present embodiment has a bobbin 3_1 and a sub-bobbin 3_2. The bobbin 3_1 schematically includes a winding axis part 30_1 extending along the X-axis, and flanges 31_1 and 41_1 at both ends in the X-axis direction of the winding axis part 30_1.

The sub-bobbin 3_2 has a sub-winding axis part 30_2. One end in the X-axis direction of the sub-winding axis part 30_2 is connected to the bobbin 3_1. The other end in the X-axis direction of the sub-bobbin 30_2 has a sub-flange 41_2.

A middle leg part 9b3 of an E-shaped core 9b is inserted in the sub-through hole 30_2a. The E-shaped core 9b contacts the plate core 9c at the face opposite to the face where the E-shaped core 9a contacts the plate core 9c. The core 9_1 is configured as such.

A through hole 30_1a of the winding axis part 30_1 is connected to a sub-through hole 30_2a of the sub-winding axis part 30_2. A middle leg part 9a3 of an E-shaped core 9a is inserted in the through hole 30_1a. An I-shaped plate core 9c is arranged in the through hole 30_1a of the winding axis part 30_1. The plate core 9c and the E-shaped core 9a are connected at the inside of the through hole 30_1a.

Similar to the first embodiment, the wound wire part 20 of the coil 2 is formed to the outer circumference of the winding axis part 30_1. The lead part 22 of the coil 2 is pulled out from the wound wire part 20 and are passed through a notch 420 formed to the flange 41_1, and then to the sub-bobbin 3_2.

In the winding axis part 30_1 of the bobbin 3_1, the wound wire part 10 of the coil 1 is formed on the outside of the wound wire part 20. A middle part 10_1 of the coil 1 which is pulled out from the wound wire part 10 are passed through the notch 420, and then to the sub-bobbin 3_2.

In the present embodiment, the lead part 22 of the coil 2 is connected to the terminal without being wound around the sub-bobbin 3_2. The coil 1 forms the wound wire part 10 by being wound around the sub-winding axis part 30_2 of the sub-bobbin 3_2.

As such, in the present embodiment, the coil 1 is wound to both of the bobbin 3_1 and the sub-bobbin 3_2. By configuring as such, the coil device 200 can easily adjust the leakage, and also elements with different functions can be integrated. For example, in the coil device 200, the coil wound around the bobbin 3_1 can function as a transformer, and a coil wound around the sub-bobbin 3_2 can function as an inductor.

As shown in FIG. 9, the cover 5 is installed so that the cover main body 50 bridges one flange 31_1 and the other flange 41_1 of the bobbin 3_1 along the X-axis direction. As such by mounting the cover 5 to the bobbin 3_1, the upper side in the Z-axis direction of the portion of the coil wound around the winding axis part 30_1 of the bobbin 3_1 is covered by the cover 5. Further, the portion of the coil is exposed which is where the coil is being wound around the sub-winding axis part 30_2 of the sub-bobbin 3_2. As such, even when the wound wire part is exposed, sufficient insulation property can be achieved.

In each embodiment discussed in above, an example of using the coil device mainly as a transformer has been discussed; however, the coil device may be used as a coil device other than a transformer.

Note that, the present disclosure is not limited to the above-mentioned embodiments, and various modification is possible within the scope of the present disclosure. Also, configurations of each embodiment may be recombined appropriately.

In the above-mentioned embodiments, the wire connection parts are arranged at four corners of the core; however, the configuration is not limited to this, and the wire connection parts may be arranged together at the upper side of one outer leg part or the upper side of the base part of the core.

In the above-mentioned embodiment, a horizontally placed coil device has been discussed which is mounted so that the winding axis of the coil is parallel to the mounting face such as the circuit board. However, the present disclosure can be applied to a vertically placed coil device which is mounted so that the winding axis is perpendicular to the mounting face such as the circuit board.

### REFERENCE SIGNS LIST

100, 200...Transformer

1, 2...Coil

10, 20...Wound wire part

11, 12, 21, 22...Lead part

10_1...Middle part

3, 3_1...Bobbin

30, 30_1...Winding axis part

30a, 30_1a...Through hole

31, 41, 31_1, 41_1...Flange

31a, 41a...Outer face

31b, 41b...Inner face

32, 42...Lead holder

320, 420...Notch

321, 322, 421, 422...Lead guiding passage

33, 43...Mounting part

3a, 3b, 3c, 3d...Engaging hole

3_2...Sub-bobbin

30_2...Sub-winding axis part

30_2a...Sub-through hole

41_2...Sub-flange

5...Cover

50...Cover main body

50a...Upper face

50b...Lower face

511, 512, 513, 514...Press-fit hole

521, 522, 523, 524...Press-fit hole

611, 612, 613, 614...Press-fit hole

621, 622, 623...Press-fit hole

5a, 5b, 5c, 3d...Engaging claw

71, 72, 81, 82...Terminal

71a, 72a, 81a, 82a...Wire connection part

71b, 72b, 81b, 82b...Intermediate part

71c, 72c, 81c, 82c...External connection part

711, 712, 713, 714...Fitting claw

721, 722, 723, 724...Fitting claw

811, 812, 813...Fitting claw

821, 822, 823...Fitting claw

9 (9a, 9b), 9_1...Core

910, 920...Outer face

9a40, 9b40...Outer face

911, 921...Upper face

9a1, 9b1...First outer leg part

9a2, 9b2...Second outer leg part

9a3, 9b3...Middle leg part

9A4, 9b4...Base part

9c...Plate core

300...Case

What is claimed is:

1. A coil device comprising:
a bobbin,
a coil comprising a wound wire part wound around the bobbin,
a terminal connecting to the coil, and
a cover protecting the wound wire part;
wherein the cover comprises a cover main body covering an outside in a height direction perpendicular to a winding axis of the of the wound wire part,
the terminal is mounted on the cover main body, and
the terminal comprises a wire connection part connecting with a lead part pulled out from the wound wire part and an external connection part connected to the wire connection part.

2. The coil device according to claim 1, wherein the external connection part is arranged closer to the winding axis than to the wire connection part viewing in the height direction.

3. The coil device according to claim 1, wherein the cover main body bridges one flange and the other flange of the bobbin.

4. The coil device according to claim 3, wherein the external connection part is arranged between the one flange and the other flange of the bobbin.

5. The coil device according to claim 1, wherein the cover main body bridges one outer leg part and the other outer leg part of a core installed to the bobbin.

6. The coil device according to claim 1, wherein the wire connection part is arranged at an inside than an outer surface in a width direction of a core installed to the bobbin.

7. The coil device according to claim 1, wherein the wire connection part is arranged at an outside of the bobbin and the cover main body viewing in the height direction.

8. The coil device according to claim 1, wherein the external connection part projects out from a surface of the cover main body.

9. The coil device 1 according to claim 1, wherein the terminal is press-fit or insert molded to the cover main body.
